(19) United States
(12) Patent Application Publication
(10) Pub. No.: US 2016/0327701 A1
(43) Pub. Date: Nov. 10, 2016

(54) DEVICE FOR HARDENING A COATING ON AN INNER WALL OF A CONDUIT HAVING AN OVAL CROSS SECTION

(71) Applicant: Heraeus Noblelight GmbH, Hanau (DE)

(72) Inventors: Ralf PRETSCH, Hanau (DE); Christian RÜTH, Mombris (DE)

(21) Appl. No.: 15/146,964

(22) Filed: May 5, 2016

(30) Foreign Application Priority Data
May 7, 2015 (DE) 10 2015 107 129.0

(51) Int. Cl. G02B 5/08; G02B 5/02; G02B 5/10

(52) U.S. Cl. CPC G02B 5/0891; G02B 5/10; G02B 5/0284

(57) ABSTRACT

A device for hardening a coating on an inner wall of a conduit having an oval cross section has at least a first UV lamp, a second UV lamp, and a guide unit having a mount for each of the UV lamps. The guide unit defines the position of the UV lamps in relation to the oval cross section of the conduit, which has a first curved section, a second curved section opposite the first, and two lateral sections. To allow for universal use and the most uniform possible UV irradiation of the inner wall, a first reflector is allocated for guiding light emitted by the first UV lamp onto the first curved section, and a second reflector is allocated for guiding light emitted by the second UV lamp onto the second curved section. The first and second reflectors differ in their reflector angle and/or their coefficient of reflection.

### BACKGROUND OF THE INVENTION

The present invention relates to a device for hardening a coating on an inner wall of a conduit having an oval cross section, which includes a first curved section, a second section opposite the first curved section, and two side sections. The device has at least two UV lamps, namely a first UV lamp, and a second UV lamp, as well as a guide unit having a mount for each of the UV lamps, wherein the guide unit fixes the position of the UV lamps with respect to the oval cross section of the conduit.

In known rehabilitation methods for conduit systems, the inner wall of the conduit to be rehabilitated is provided with a coating, wherein frequently fiber compound materials are introduced into the conduit. Fiber compound materials in this sense are, for example, textile materials that are saturated with a UV-hardenable material, for example with a resin. The shape of such fiber compound materials is often adapted to the shape of the inner wall of the conduit; they are also designated as liners or plastic liners.

Such a coating deposited in the conduit system must be hardened (cured) after introduction into the conduit system. This can take place, for example, thermally by the introduction of hot water or steam or optically by the use of ultraviolet radiation. The device according to the invention relates to the optical hardening of a coating by ultraviolet radiation.

### PRIOR ART

Known devices, which are used for irradiating conduit coatings, comprise two or more UV lamps for generating ultraviolet radiation, as well as a guide unit for guiding the UV lamps through the conduit to be irradiated. The guide unit is constructed such that it can be pulled or pushed through the conduit. Usually the guide unit is provided with rollers, so that simple movement of the guide unit relative to the conduit is made possible. The guide unit also has several mounts for the UV lamps.

To achieve high quality rehabilitation of the conduits, it is necessary to irradiate the coating or the plastic liner as homogeneously as possible. To do this, it is necessary to adhere to the most uniform distances of the UV lamps to the surface as possible.

Many known guide units, however, are regularly designed for a predetermined conduit shape, namely conduits having round circular cross sections. They are also regularly designed for a certain conduit inner diameter.

Especially for the irradiation of conduit shapes having oval cross sections, these guide units can be centered only with difficulty. In addition, the shape of the guide unit or the conduit shape works against a uniform irradiation of the inner wall.

From German published patent application DE 10 2009 025 829 A1 a device for rehabilitating pipes and conduits is known, which can be used universally for a plurality of different pipe/conduit diameters and also for different pipe/conduit shapes. For this purpose, the device has mounts for arms, wherein arms and rollers of different dimensions can be inserted into these mounts.

The arms and rollers having different dimensions determines the orientation of the guide unit with respect to the cross section of the conduit to be irradiated. At the same time, the arms and rollers contribute to centering the guide unit in the channel.

Indeed, a centering of the guide unit is accompanied by a reduction of the differences in the distances of the UV lamps to the inner wall of the conduit and a more uniform irradiation. However, such centering can only improve the differences in the distances, but cannot completely optimize them. Due to the egg-shaped, oval conduit shape, after centering, the shortest distances of the UV lamps to the surface to be irradiated by these lamps are still different. This applies especially with respect to the distances to the first and the second section of the oval cross section and the distances to the side sections.

### BRIEF SUMMARY OF THE INVENTION

The invention is therefore based on the object of providing a device for hardening a coating on an inner wall of a conduit having an oval cross section that, on one hand, can be used universally and, on the other hand, makes possible the most uniform irradiation of the inner wall with ultraviolet radiation.

This object is achieved starting from a device of the type mentioned at the outset in that, according to the invention, a first reflector is allocated to the first UV lamp for guiding the light emitted by the first UV lamp onto the first curved section, and a second reflector is allocated to the second UV lamp for guiding the light emitted by the second UV lamp onto the second curved section, wherein the first reflector and the second reflector differ in their reflector angle and/or in their coefficient of reflection.

For the hardening of coatings in pipes and conduits, it is basically desired to irradiate the coating to be hardened as uniformly as possible. A uniform irradiation contributes to the prevention of irradiation damage and an incomplete hardening and thus to a long service life of the coating.

The homogeneity of the irradiation is influenced by the structural design of the guide unit. Because the pipes and conduits to be irradiated are normally different in practice, for example with respect to their inner diameter or their cross-sectional shape, an optimized, separate guide unit must be preferably provided for each pipe/conduit shape. This is complicated and cost-intensive.

Therefore, there is the need for a universal guide unit that can be easily retrofitted and adapted to different pipe shapes. Indeed, solutions are known in the prior art for this problem, in which the guide unit is centered with respect to the pipe/conduit to be irradiated and which enable a sufficiently homogeneous irradiation. Special problems with respect to the homogeneity of the irradiation are produced, however, if the pipe/conduit shape deviates from a round circular shape, in particular for oval cross-sectional profiles, for example for pipes/conduits having an egg-shaped profile, archway-shaped profile, or horseshoe-shaped profile. The device according to the invention therefore relates to devices that can be used universally in pipes and conduits having oval cross-sectional profiles, in particular having rectangular, square, or polygonal cross-sectional profiles. It is understood that this device is designed both for pipes and also for conduits having oval cross-sectional shapes. For simplifying the language, only conduits are mentioned below, but this does not limit the subject matter of the invention only to a use of the device in conduits; instead the device can also be used in pipes having an oval cross-sectional shape.

Indeed, the guide unit can also be centered for oval cross-sectional shapes with respect to the cross section. Since the guide unit itself should be universally usable, that is, it must even be suitable for round circular cross-sectional shapes, by insertion of such a guide unit in a conduit having oval cross section, no uniform shortest distance of the UV lamps to the surface to be irradiated can regularly be set. Mirror-symmetric, oval cross-sectional shapes have a dimension in the longitudinal direction and a comparatively shorter extent in the transverse direction. Usually, the distance to the inner wall from a UV lamp provided for irradiating the cross section in the transverse direction is smaller than that of a UV lamp provided for irradiating the cross section in the longitudinal direction. These differences with respect to the shortest distances of the UV lamps contribute to non-uniform irradiation of the inner wall of the conduit.

Therefore, according to the invention, two modifications of the prior art are proposed, of which one relates to the allocation of at least two UV lamps each to a certain section of the cross section of the conduit to be irradiated and the other relates to the provision of at least two different reflectors for the directed guidance of the radiation emitted by the at least two UV lamps onto the associated conduit cross-sectional sections.

The number of UV lamps is adapted to the oval cross-sectional shape of the conduit to be irradiated. The cross section of such conduits can be regularly divided into four functional sections, namely a first curved section, a second section opposite to the first curved section, and two lateral sections.

The cross-sectional shape often has an axis of symmetry, so that the two lateral sections regularly have identical designs and can be irradiated in the same way. Preferably, the device according to the invention therefore comprises at least three UV lamps, namely a first UV lamp designed essentially for irradiating the first section, a second UV lamp designed essentially for irradiating the second section, and a third UV lamp designed for irradiating the two lateral sections.

Preferably, the first, second, and—if present—third UV lamps have identical constructions. The term “identical construction” relates to the basic shape of each lamp, that is to the length of the lamp bulb, the diameter of the lamp bulb, and its electrical operating parameters. The use of lamps having identical construction enables an especially simple, thus uniform, electrical contacting of the UV lamps. In particular, socket distances, the type of socket, and the design of the electrical supply unit can have an identical design that is independent of the position of the lamp with respect to the guide unit. In this way, a simple construction, as well as a simple control of the lamps, and thus an economical device, is made possible.

In order to nevertheless achieve a uniform irradiation power with the use of UV lamps that have identical constructions, it is provided according to embodiments of the invention that at least two of the UV lamps, namely the first and the second UV lamps, are each provided with a reflector. The allocation of a reflector concerns the first and the second UV lamp, because the shortest distances of these lamps to the inner wall are frequently different in size. If a third UV lamp is provided, the shortest distance of these lamps is regularly larger than the shortest distance of the third UV lamp to the inner wall. Both the first section and also the second section of the conduit must be irradiated with a greater portion of the radiation emitted by each of the UV lamps in order to guarantee a uniform irradiation. In one advantageous construction, however, a reflector could also be allocated to the third UV lamp.

The reflectors contribute to the situation that the radiation emitted by the first and second UV lamps is guided in the direction toward the first or the second section of the conduit. Thus, a large portion of the radiation emitted by the first or the second UV lamp is available directly for irradiation of each allocated section of the conduit. The first and second reflectors are designed such that the radiation emitted by them irradiates a smaller surface area. In this way, the irradiation power is increased.

Due to the oval cross-sectional shape of the conduit, different shortest distances of the first and second UV lamp to the inner wall of the conduit are produced. Therefore, according to embodiments of the invention it is provided that the first reflector and the second reflector are different. Possible differences can be, for example, the reflector angle and/or the coefficient of reflection.

A reflector generates an illuminated field. The reflector angle—also called emission angle—indicates the opening angle of the emitted light beam, that is, the angle at which the lamp unit made of the reflector and associated UV lamp outputs light. The smaller the reflector angle is, the greater is the collimation of the light.

The coefficient of reflection describes the ratio of the power of the light reflected by the reflector to the power of the light incident on the reflector. A higher coefficient of reflection is associated with low radiation losses.

Therefore, because the two reflectors are different, an optimal adaptation of the irradiation power to the geometrical cross-sectional shape of the conduit is made possible.

It has proven effective if the reflector is a separate reflector. Preferably, the guide unit has, in addition to mounts for the UV lamps, also a mount for a separate reflector. In this way, a simple and quick adaptation of the reflectors to the cross-sectional shape of the conduit to be irradiated is made possible.

In a preferred construction of the device according to an embodiment of the invention, it is provided that the third UV lamp is designed for irradiating one of the lateral sections, and that the device comprises a fourth UV lamp designed for irradiating the other lateral section.

In the simplest case, the device comprises, viewed in cross section, a single third UV lamp. To enable a uniform irradiation of the inner wall, it is assumed that the center point of the third UV lamp is centered with respect to the conduit. In this way, a simple and compact irradiation device is produced. In this context, it has proven effective if the third UV lamp is provided with two additional reflectors, of which one is allocated to the side facing the first UV lamp and the other is allocated to the side of the third UV lamp facing the second UV lamp. Through such an additional reflector arrangement, an emission of radiation by the third UV lamp is reduced in the direction of the first and second UV lamp. This arrangement makes possible a high radiation efficiency of the device.

On the other hand, it has proven advantageous if a UV lamp is allocated to each of the two lateral sections. Here, a section of the conduit is allocated to each UV lamp, whereby a simple adaptation of the device to the cross-sectional shape of the conduit is made possible. In addition, such a device makes possible a simple, homogeneous irradiation of non-symmetrical cross-sectional shapes.

It has proven advantageous if the first reflector and/or the second reflector is designed such that it generates an oval illumination field.

An oval illumination field has a field longitudinal axis and a field transverse axis. It has a high irradiation power along the longitudinal axis. A high irradiation efficiency is achieved if the field longitudinal axis runs parallel to a longitudinal axis of the conduit. This arrangement makes it possible for the illumination fields of adjacent first and second UV lamps arranged one behind the other in the longitudinal axis of the conduit to overlap with the formation of a homogeneous total irradiation field.

It has proven advantageous if the first UV lamp generates a first illumination field and the second UV lamp generates a second illumination field, and if the first and the second reflectors are designed such that the first and second illumination fields do not overlap. In this way, a simple setting of a homogeneous irradiation is made possible, because the first and second illumination field can be adjusted independently of each other and optimized.

In one advantageous construction of the device according to the invention, the first UV lamp has a first lamp bulb and the second UV lamp has a second lamp bulb, wherein the first reflector is mounted on the first lamp bulb and/or the second reflector is mounted on the second lamp bulb.

A reflector mounted on the lamp bulb contributes to a compact design of the device according to the invention, and indeed with the same effectiveness with respect to the homogeneity of the irradiation power.

Lamp bulbs regularly have an outer surface and an inner surface; they are usually formed as hollow cylinders. The first reflector can be mounted on the outer surface and/or the inner surface of the first lamp bulb. A reflector mounted on the outer surface is simple to produce. A reflector mounted on the inner surface reduces radiation losses that are caused by penetration and the back reflection of radiation reflected on the reflector by the hollow cylinder of the lamp bulb. Preferably, the second reflector is likewise mounted on the outer surface and/or the inner surface of the second lamp bulb.

In this context it has proven effective if the first lamp bulb has a circular cross-sectional shape with a center point and if the first reflector is a curved reflector strip that covers a circular arc of the first lamp bulb having a central angle in the range from 120° to 225°.

The reflector strip covers the circular arc of the first lamp bulb completely or partially, viewed in the direction of a longitudinal axis of the lamp bulb. A reflector strip that covers a circular arc with the central angle mentioned above has a reflector angle in the range from 135° to 240°. Such a reflector is suitable for focusing the UV radiation emitted by the first UV lamp in the direction of the first curved section. The greater the central angle is, the more strongly focused is the emission. For a central angle of less than 120°, the effect of the focusing emission is lost. A central angle of greater than 225° is associated with a high focusing and an irradiation of a small area of the cross section.

It has proven effective if the second lamp bulb has a circular cross-sectional shape with a center point and if the second reflector is a curved reflector strip that covers a circular arc of the second lamp bulb with a central angle in the range of 180° to 315°, preferably of 250° to 315°.

The central angle range corresponds to a reflector angle in a range of 45° to 180°. Such an area contributes to good focusing of the radiation emitted by the second UV lamp. The shortest distance of the first UV lamp to the inner wall is less than the shortest distance of the second UV lamp to the inner wall. A central angle of the second reflector strip in the range mentioned above allows for the larger shortest distance of the second lamp to the inner wall of the conduit.

Advantageously, the first reflector and/or the second reflector is a diffusely scattering reflector.

Diffusely scattering reflectors reflect light incident on them in different directions, so that scattered light is produced. Scattered light is especially suitable for generating uniform irradiation intensities, because maximum values of the irradiation intensity that occur are attenuated, so that differences in the irradiation intensities are reduced. Alternatively, the first reflector and/or the second reflector can have a reflective surface. Here, it has proven effective that the first and/or the second reflector is an asymmetric reflector. An asymmetric reflector generates an asymmetric illumination field; it is suitable, in particular, for generating an oval illumination field.

It has proven favorable if the first reflector and/or the second reflector is produced from opaque quartz glass or from ceramic.

A reflector made of opaque quartz glass or from ceramic has diffusely reflecting properties. For the reflection on such a reflector, only low reflection radiation losses occur. It is also simple and economical to produce. Preferably, the first and/or the second reflector is a coating made of opaque quartz glass deposited on the respective lamp bulb.

In another preferred construction of the device according to the invention, it is provided that the first UV lamp, the second UV lamp, and the at least one third UV lamp each have a center axis and are arranged in a row one behind the other in the guide unit, whereby their center axes run parallel to each other.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a schematic, cross-sectional view of a device according to a first embodiment of the invention, in which four UV lamps are arranged in a cross-sectional plane in an egg-shaped conduit;

FIG. 2 is a schematic, cross-sectional view of a device according to a second embodiment of the invention, having three UV lamps arranged in a cross-sectional plane in an egg-shaped conduit;

FIG. 3 is a schematic, cross-sectional view of a device according to a third embodiment of the invention, in which four UV lamps are arranged having a reflector mounted on the lamp bulbs; and

FIG. 4 is a schematic, perspective view through the conduit wall of an arrangement of a device according to a fourth embodiment of the invention, in which the UV lamps are arranged one behind the other viewed in the longitudinal direction of the conduit.

### DETAILED DESCRIPTION OF THE INVENTION

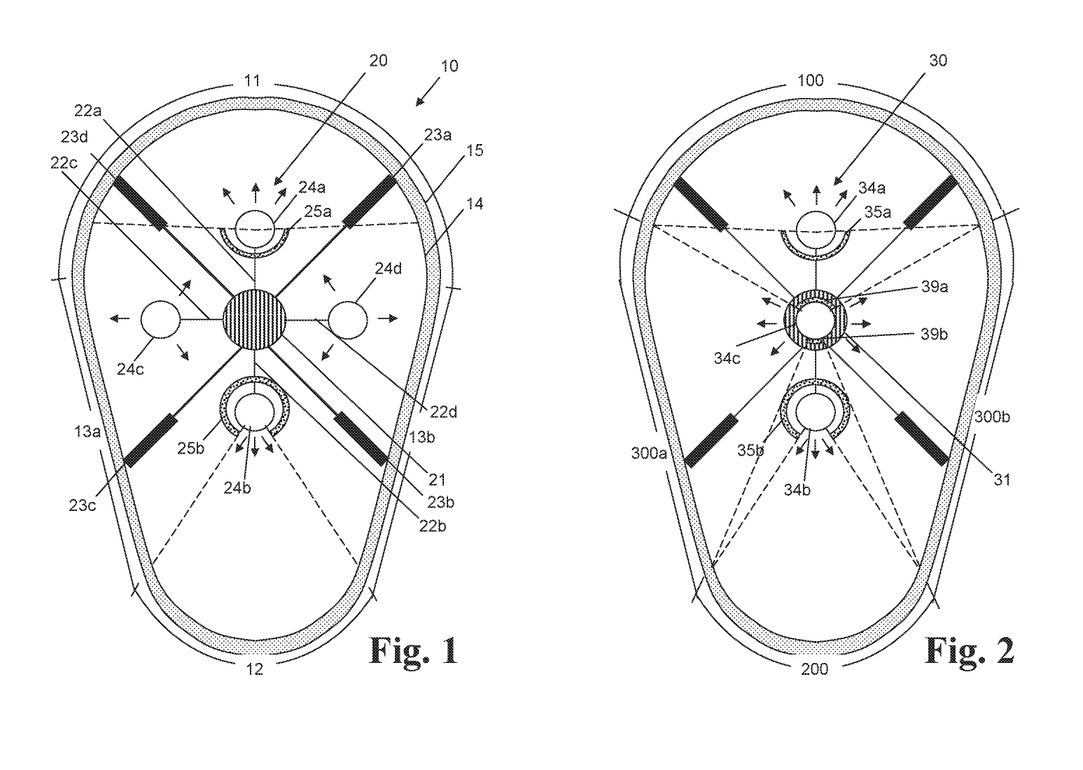

FIG. 1 shows, in a cross-sectional representation, a conduit 10 in which a first embodiment of a device according to the invention is arranged for hardening plastic liners on an inner wall of a conduit 10. The device is indicated as a whole by reference number 20.

The conduit 10 has an egg-shaped cross section having four sections, namely a first curved section 11, a second curved section 12, and two lateral sections 13a, 13b. It has an inner wall 14 and an outer wall 15. A coating made of opaque quartz glass (for example QRC®, Heraeus) (not shown) is deposited on the inner wall.

To harden the coating, the device 20 is pulled with a transport device (not shown) through the conduit. To ensure the most uniform possible irradiation of the coating, the device 20 has a guide unit 21. The guide unit 21 is provided with mounts 22a, 22b, 22c, 22d for UV lamps; it establishes the position of the UV lamps in relation to the oval cross section of the conduit.

The device 20 has a modular design and comprises several modules arranged one behind the other. FIG. 1 shows only a cross section of one module of the device 20. The other modules (not shown) have identical constructions.

In the cross-sectional plane shown in FIG. 1, four UV lamps 24a, 24b, 24c, 24d are arranged. The UV lamps 24a, 24b, 24c, 24d are identical construction medium-pressure mercury discharge lamps having a cylindrical lamp tube made of quartz glass. The lamp tube of each of the UV lamps 24a, 24b, 24c, 24c has a diameter of 45 mm and a length of 150 mm; they each have a nominal output power of 1000 W.

The position of the UV lamps 24a, 24b, 24c, 24d in relation to the conduit cross section is established by the guide unit 21. The first UV lamp 24a is allocated to the curved section 11 of the conduit 2. Between the guide unit 21 and the UV lamp 24a there is a reflector 25a, which bundles the light emitted by the first UV lamp 24a and reflects onto the first curved section 11 of the conduit 10. The reflector 25a is a separate component made of hammered aluminum. The first UV lamp 24a has a shortest distance from the first curved section of 150 mm.

A separate reflector 25b made of hammered aluminum is also allocated to the second UV lamp 24b. The reflector surrounds the UV lamp 24b such that a reflector angle of 80° is achieved. The reflector consequently covers the one circular arc of 280° of the lamp bulb of the UV lamp 24b. The shortest distance between the second UV lamp 24b and the second curved section 12 of the conduit 10 is 300 mm. Due to the low reflector angle of the reflector 25b, the light emitted by the UV lamp 24b is focused on the second curved section 12 of the conduit 10, and the reflector 25b thus contributes to an increased irradiation output power in this section.

No reflector is allocated to the UV lamps 24c, 24d, so that they basically emit radiation in all spatial directions. They are provided primarily for irradiating the lateral sections 13a, 13b of the conduit.

In addition, the guide unit 21 is provided with rollers 23a, 23b, 23c, 23d, which should enable a simple movement of the guide unit 21 through the conduit 10.

FIG. 2 shows a second embodiment of the device according to the invention, which is designated overall by reference numeral 30. The device 30 is arranged in a conduit as described for FIG. 1.

The device 30 comprises a guide unit 31, a first UV lamp 34a, a second UV lamp 34b, and a third UV lamp 34c.

The guide unit 31 differs from the guide unit 21 of FIG. 1 in that the mount for the third UV lamp 34c is arranged in the center of the guide unit 31.

The first UV lamp 34a and the second UV lamp 34b correspond to the first UV lamp 24a or the second UV lamp 24b of FIG. 1. This also relates to the reflector allocated to the first UV lamp and to the reflector allocated to the second UV lamp.

The third UV lamp 34c is arranged such that it irradiates the two lateral sections of the conduit uniformly. The third UV lamp 34c is provided with two additional reflectors 39a, 39b, which are deposited directly on a lamp bulb of the third UV lamp 34c in the form of a coating made of opaque quartz glass. The additional reflector 39a prevents an emission of ultraviolet radiation in the direction of the first UV lamp 34a. The second additional reflector 39b prevents an emission in the direction of the second UV lamp 34b. The reflectors 35a, 35b and the additional reflectors 39a, 39b are arranged such that the first UV lamp 34a irradiates a first illumination field 100 of the conduit and that the second UV lamp 34b irradiates a second illumination field 200 of the conduit. The third UV lamp 34c irradiates an illumination field on the two lateral sections 300a, 300b of the conduit. Here, the reflectors are arranged such that the illumination fields irradiated by the UV lamps 34a, 34b, 34c do not overlap. In this way, a simple adjustment of the irradiation intensity to the inner wall is made possible, because overlapping areas can remain unaccounted for.

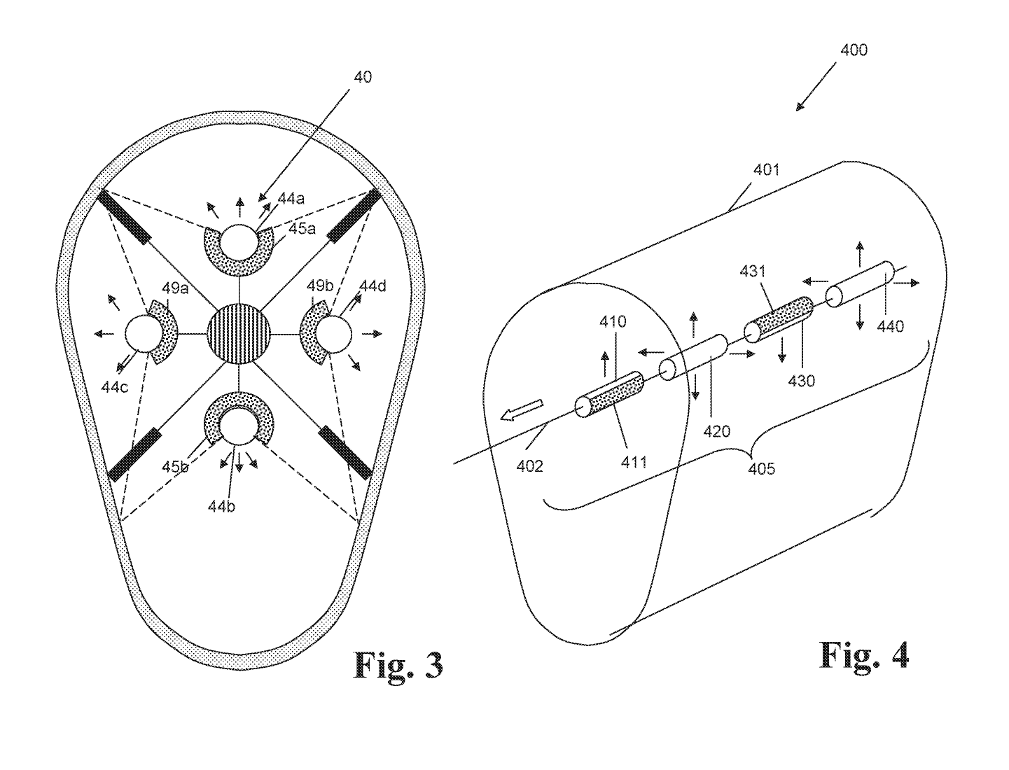

FIG. 3 shows a third embodiment of the device 40 according to the invention, which differs from the device of FIG. 1 essentially in that the respective reflectors 45a, 45b, 49a, 49b are deposited directly on the respective lamp bulbs of the UV lamps 44a, 44b, 44c, 44d. In addition, the reflector angles of the reflectors 45a, 45b, 49a, 49b are different.

The reflectors are made of opaque quartz glass. The reflector angles (central angles) are:

Reflector 44a: 135°(225°)

Reflector 45b: 110°(250°)

Reflectors 49a, b: 225°(135°)

FIG. 4 shows an alternative embodiment of the device according to the invention, which is designated overall by reference numeral 400. The device 400 is arranged for better clarity in a conduit 401 having an oval cross-sectional shape.

The device 400 comprises a guide unit having multiple work units, wherein only one work unit is shown schematically in FIG. 4 as an example. The work unit 405 comprises four identical construction UV lamps 410, 420, 430, 440, which are arranged one behind the other viewed in the longitudinal direction 402 of the conduit 401. The UV lamps 410, 420, 430, 440 differ in that they are partially provided with a reflector that defines a reflector angle (emission angle) for the radiation emitted from these lamps.

The UV lamp 410 is provided with a reflector 411 made of opaque quartz glass. The main emission direction is marked by an arrow.

The UV lamps 420, 440 have identical constructions; they have no reflector and thus emit radiation in all spatial directions (shown by four arrows).

The UV lamp 430 is also provided with a reflector. It has an identical construction to that of UV lamp 410, with the difference that it assumes a different orientation in the device 400. The main emission direction of the UV lamp 430 is opposite the main emission direction of the UV lamp 410; it is also shown by an arrow.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I/We claim:

1. A device for hardening a coating on an inner wall of a conduit having an oval cross section, the device comprising a first curved section, a second curved section opposite the first curved section, and two lateral sections, at least two UV lamps including a first UV lamp and a second UV lamp, a guide unit having a mount for each of the UV lamps, wherein the guide unit defines a position of the UV lamps in relation to the oval cross section of the conduit, a first reflector allocated to the first UV lamp for guiding light emitted by the first UV lamp onto the first curved section, and a second reflector allocated to the second UV lamp for guiding light emitted by the second UV lamp onto the second curved section, and wherein the first reflector and the second reflector differ in their reflector angle and/or in their coefficient of reflection.

2. The device according to claim 1, further comprising at least one third UV lamp, wherein the at least one third UV lamp is configured to irradiate at least one of the lateral sections.

3. The device according to claim 2, wherein the third UV lamp is configured to irradiate one of the lateral sections, and further comprising a fourth UV lamp configured to irradiate the other lateral section.

4. The device according to claim 1, wherein at least one of the first and second reflectors is configured to generate an oval illumination field.

5. The device according to claim 1, wherein the first UV lamp has a first lamp bulb, the second UV lamp has a second lamp bulb, the first reflector is deposited on the first lamp bulb, and/or the second reflector is deposited on the second lamp bulb.

6. The device according to claim 5, wherein the first lamp bulb has a circular cross-sectional shape with a center point and the first reflector is a curved reflector strip that covers a circular arc of the first lamp bulb with a central angle in a range of 120° to 225°.

7. The device according to claim 6, wherein the second lamp bulb has a circular cross-sectional shape with a center point, and wherein the second reflector is a curved reflector strip that covers a circular arc of the second lamp bulb with a central angle in a range of 180° to 315°.

8. The device according to claim 7, wherein the second reflector is a curved reflector strip that covers a circular arc of the second lamp bulb with a central angle in a range of 250° to 315°.

9. The device according to claim 1, wherein at least one of the first reflector and the second reflector is a diffusely scattering reflector.

10. The device according to claim 1, wherein at least one of the first reflector and the second reflector is made of opaque quartz glass or ceramic.

11. The device according to claim 2, wherein the first UV lamp, the second UV lamp, and the at least one third UV lamp each has a center axis and are arranged in a row one behind another in the guide unit, and wherein their center axes run parallel to each other.
